(19) United States
(12) Patent Application Publication
(10) Pub. No.: US 2014/0040362 A1
(43) Pub. Date: Feb. 6, 2014

(54) Systems and methods of online communication and commerce based on publish/subscribe pattern

(71) Applicant: Kevin Le, Austin, TX (US)

(72) Inventor: Kevin Le, Austin, TX (US)

(21) Appl. No.: 13/562,318

(22) Filed: Jul. 31, 2012

(51) Int. Cl. G06F 15/16

(52) U.S. Cl. 709/204

(57) ABSTRACT

Systems and methods of handling online communication and commerce via a publish/subscribe pattern are described. Publishers and subscribers can post event messages to broadcast or subscribe to subjects of interest. Each event message must contain four required dimensions, namely WHO, WHAT, WHEN and WHERE. The system will match publishers' and subscribers' events by evaluating all four dimensions for matching conditions. When there are matches, the system will notify users (publishers and/or subscribers). If users respond to events notification, then the system will handle communication and/or commercial transactions.

### BACKGROUND

The present invention relates to events publishing and subscribing systems and methods. It allows online users to communicate and/or participate in commercial transactions with explicit intents via events matching and notification systems and methods.

Since the mid-1990s the Internet has had a drastic impact on communication and commerce. From email to instant messaging, from blogging to social network, from Craigslist to eBay, from Google's search Ads to Groupon, communication and commerce methods have evolved over time. However, online users have very little control over what is delivered to them. Users also waste a lot of time browsing online to find what they want to buy (sometimes at the price they want to pay). Thus, a system that allows users to explicitly express their intents and matches them will be useful.

In communication methods such as email and instant messaging, senders can spam receivers' emails or messaging inboxes. All it takes is that senders know receivers' email addresses or instant messaging IDs.

More recently, social network message publication services such as Twitter and Facebook give users some control over whose postings users want to see. However, users have no control over what they want to see. For example, if a user is interested in following someone then he or she will see everything that person sends out. There is no way to follow someone in only a chosen topic. Thus a system that allows more granular control is helpful to users.

Online deals sites such as Groupon require a lot of marketing effort. Salespersons have to approach businesses to get deals. Members' mail boxes then get spammed with emails from deals' providers, whether or not they want to see them. With events matching and automatic transaction handling, businesses can create self-service promotions anytime they want and at any price they feel comfortable by posting deals, and users can subscribe to only deals they are interested in. When users decide to buy, the system can handle payment automatically. The process can cut out the overhead of the Groupon model where salespersons have to call businesses to get deals and then email them to users.

With explicit intent event posting, the publishers have control over their target audience, and subscribers have control over whether they want to see published contents that include them as target audience. Together with event matching notification, communication handling and automatic transaction handling the whole system will empower online communication and commerce in new ways that are convenient and useful for online users.

### SUMMARY

Generally, these are systems and methods of handling online communication and commerce based on users' explicit intents using a publish/subscribe pattern.

In one implementation, a method of event posting is provided (FIG. 1). The method comprises four required dimensions (WHO, WHAT, WHEN, WHERE) of an event. The WHO dimension corresponds to a user's social groups, similar to those implemented in social network sites (public, friends, family, etc.). The WHEN dimension corresponds to the time span of an event, namely start time and end time. The WHERE dimension corresponds to the geographical area of an event; geographical area can be implemented as a geo-location with some distance radius. The WHAT dimension corresponds to the subject of interest which can have additional attributes such as categories, tags/keywords or price, etc.

In one implementation, a method of event matching and notification is provided. Event matching compares matching conditions of publishers' events to subscribers' events (FIG. 2). If matching conditions of all four required dimensions (WHO, WHAT, WHEN, WHERE) are satisfied, users will be notified by the communication methods of choice.

In one implementation, a method of communication is provided based on users' responses to notification. Users can respond to notification with communication messages sent to parties of interest.

In one implementation, methods of transaction processing are provided based on users' response to notification. Users can respond to notification with an action to buy a product or service; the system will handle commercial transactions with an automatic online payment process.

The above-mentioned and other features of this invention and the manner of obtaining and using them will become more apparent, and will be best understood, by reference to the following description, taken in conjunction with the accompanying drawings. The drawings depict only typical embodiments of the invention and do not therefore limit its scope.

### BRIEF DESCRIPTION OF THE DRAWINGS

FIG. 1 is a user interface mock-up illustrating the composition of an event with the required WHO, WHEN, WHERE and WHAT dimensions in accordance with various embodiments of the invention.

FIG. 2 is a Venn diagram illustrating conditions for events matching in accordance with various embodiments of the invention.

FIG. 3 is a flowchart illustrating the event publishing process in accordance with various embodiments of the invention.

FIG. 4 is a flowchart illustrating the event subscribing process in accordance with various embodiments of the invention.

### DETAIL DESCRIPTIONS

### Overview

Generally, systems and methods of handling online communication and commerce based on a publish/subscribe pattern are described. Users can publish or subscribe to subjects of interest by posting events that describe explicit intents. In an implementation, the system will match published and subscribed events with similar intents and notify users if there are matches. When users respond to matched events, the system will handle communication and/or commercial transactions.

### Event Posting

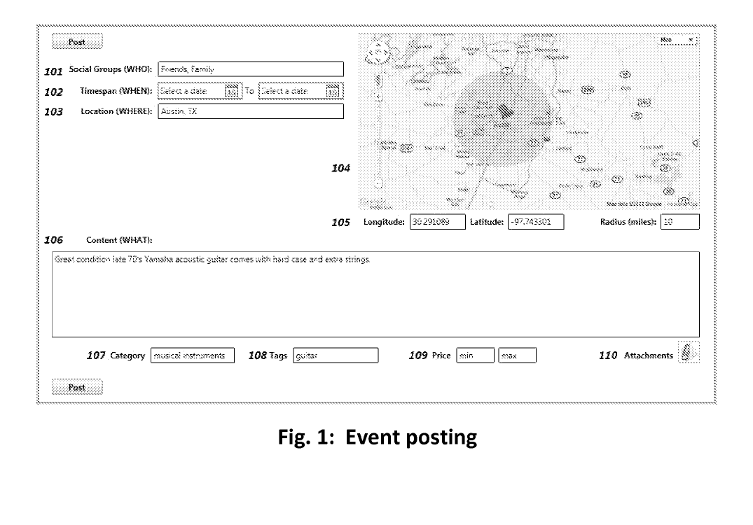

Users can publish or subscribe to a subject of interest by posting an event. An event must have at least four dimensions, namely WHO, WHAT, WHEN, WHERE (FIG. 1).

The WHO dimension (101) describes a user's social group(s) of an event. The system could be implemented by integrating with social network features to support the WHO dimension or by integrating with third party social networks such as Facebook, Twitter or Google Plus, etc. This dimension can also be hidden from users if default values are set in the user's profile.

The WHEN dimension (102) describes the time span of interest of an event. The time span will have a start time and an end time. In the user interface mock-up diagram (FIG. 1), the start time and end time are shown as date time selector. However, in an implementation a double-ended slider or any compatible control could be used to help users with better data entry experience. This dimension can also be hidden from users if default values are set in the user's profile.

The WHERE dimension (103) describes the location of an event as a geo-location within a given distance radius. In the user interface mock-up diagram (FIG. 1), users can enter geo-location information by different ways. Users can type a location in a textbox control (103) as the name of a place and the system can convert it to a geo-location on a map control (104). Users can also change the geo-location by dragging it around in the map control or by entering longitude and latitude and as distance radius in text box controls (105). This dimension can also be hidden from users if default values are set in the user's profile.

The WHAT dimension (106) describes the subject details which can optionally have categories (107), tags/keywords (108), price range (109) and content attachments (110), etc.

Dimensions can have hidden default values set in a user's profile and not shown in the event posting form UI. When a dimension is shown in the UI, it can be implemented in any form that is convenient for users on the deployed application platforms.

Dimensions can be combined into a single text entry field, and the system will automatically parse the content into appropriate dimensions. This implementation can simplify event posting data entry on mobile devices.

Optional dimensions can be added if there are cases that need more dimensions.

### Conditions for Matching

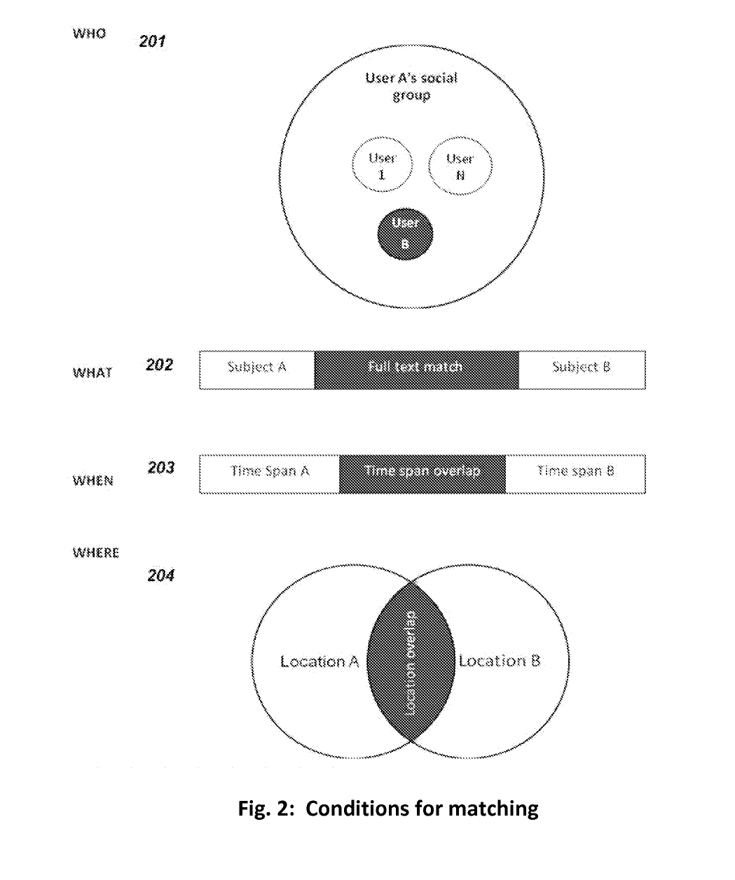

When a user posts a publishing event, the system will query subscribed events to find matches. Similarly, when a user posts a subscribing event, the system will query published events to find matches. For subscribed events to match published events, all the dimensions have to match (FIG. 2).

The WHO dimension (201) matches when the publisher belongs to the social group(s) indicated in the subscribed event. Similarly, it matches when the subscriber belongs to the social group(s) indicated in the published event.

The WHAT dimension (202) matching can use available full text search engines, built-in full text query of modern databases or a custom implementation. The WHAT dimension can also have categories, tags or keywords to aid the accuracy of full text query.

The WHEN dimension (203) matches when a subscribing event's time span overlaps with a publishing event's time span.

The WHERE dimension (204) matches only if the subscribing event's location overlaps with the publishing event's location. In an implementation, event location can be represented by a map point (geo-location with longitude and latitude) with a radius distance.

### Event Publishing Process Flow

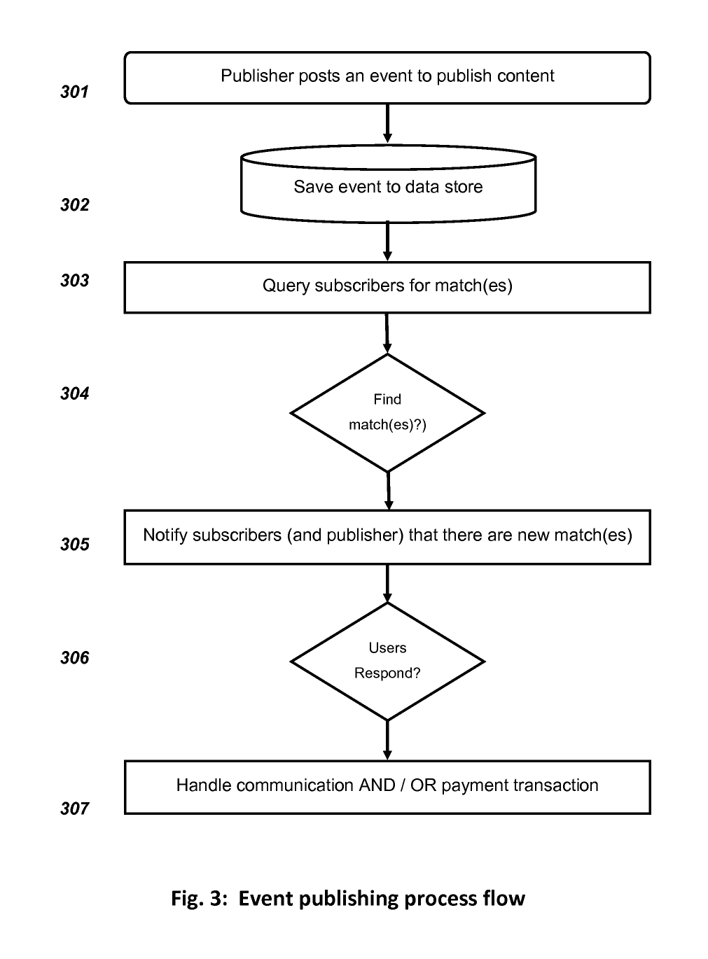

FIG. 3 is an illustration of an event publishing process flow. Event publishing starts when a user posts an event to offer goods, services or shared contents, etc. (301).

In an implementation, the system first stores the published event in the data store (302). The system then queries subscribers' events to find matches (303), with conditions for matching discussed in the above section (FIG. 2). If there are matches (304), subscribers (and optionally the publisher) will be notified (305) via users' communication method of choice such as email, text messaging, phone call, and/or system inbox. When a user responds to an event match (306), the system handles the communication or commercial transaction. In case the response action is related to buying goods or services, the system will handle payment using some of the available online payment processing services (307).

### Event Subscribing Process Flow

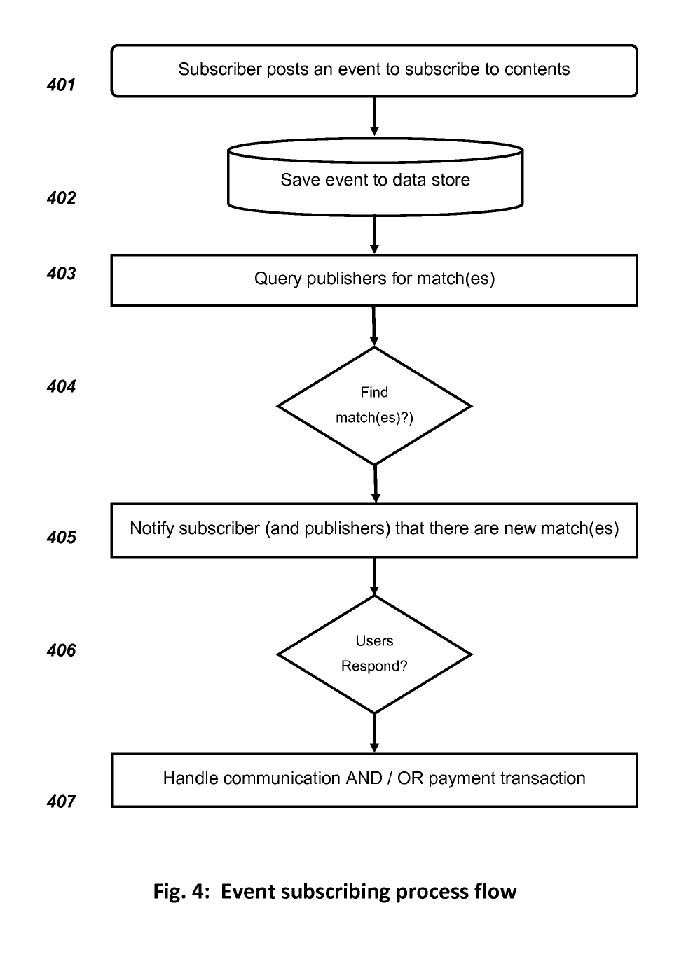

FIG. 4 is an illustration of an event subscribing process flow. Event subscribing starts when a user posts an event to look up goods, services or shared contents, etc. (401).

In an implementation, the system first stores the subscribed event in the data store (402). The system then queries publishers' events to find matches (403), with conditions for matching discussed in the above section (FIG. 2). If there are matches (404), the subscriber (and optionally publishers) will be notified (405) via users' communication method of choice such as email, text messaging, phone call, and/or system inbox. When a user responds to an event match (406), the system handles the communication or commercial transaction. In case the response action is related to buying goods or services, the system will handle payment using some of the available online payment processing services (407).

### CONCLUSION

Although the invention has been described in language specific to structural features and/or methodological acts, it is not to be understood that the invention defined in the appended claims is limited to the specific features or acts described. Rather, the specific features and acts are disclosed as example forms of implementing the claimed invention.

The invention can be implemented as a stand-alone system with its own integrated social network features or be integrated with third parties' social network such as Facebook, Twitter, Google Plus, etc.

What is claimed is:

1. Systems and methods of online communication and commerce based on a publish/subscribe pattern comprising:
Publishing/subscribing to subjects of interest based on event posting; matching events based on four required dimensions; notifying users when events match; handling users communication and/or commercial transactions based on their responses to events notification.

2. A method of claim 1 wherein event posting (publishing or subscribing) is based on the four required dimensions, namely WHO, WHAT, WHEN and WHERE.

3. A method of claim 1 wherein querying of matching events require that all four conditions of matching are satisfied.

4. A method of claim 1 wherein users get notified when they have matched events. Users should be able to specify notification methods, whether it is their system inbox, email, text messaging, phone call or their social networks' status updates, etc.

5. A method of claim 1 wherein communication is handled when users respond to events notification by initiating a communication method.

6. A method of claim 1 wherein commercial transactions are handled when users respond to events notification with a purchase action.

7. A method of claim 2 that further comprises optional dimensions and attachments such as documents and/or media files.

8. A method of claim 2 where the WHO dimension is integrated with social groups of third party social networks or the system's own social network.

9. A method of claim 2 where the WHAT dimension further comprises additional information such as categories, tags, keywords, etc. to aid events matching query logic.

10. A method of claim 2 that further comprises extra UI controls and optional dimensions to aid data entry and event matching query logic.

11. A method of claim 2 that further comprises default settings in users' profile that can automate user entry behind the scene, thus simplifying the event posting procedure.

12. A method of claim 3 wherein the condition for matching the WHO dimension can be checked against third party social networks or the system's own social groups data.

13. A method of claim 3 wherein the condition for matching the WHAT dimension can be queried with full text search and additional helper attributes such as categories, tags, keywords, etc.

14. A method of claim 3 wherein the condition for matching the WHEN dimension is true if the time span of events overlap.

15. A method of claim 3 wherein the condition for matching the WHERE dimension is based on the distance within a geo-location point on the map.
